(19) United States
(12) Patent Application Publication
(10) Pub. No.: US 2002/0194340 A1
(43) Pub. Date: Dec. 19, 2002

(54) Enterprise storage resource management system

(76) Inventors: Bryan D. Ebstyne, Dusseldorf (DE); Michael J. Ebstyne, Seattle, WA (US)

Correspondence Address: THE LAW OFFICES OF MIKIO ISHIMARU, 1110 SUNNYVALE-SARATOGA ROAD, SUITE A1, SUNNYVALE, CA, 94087, US

(21) Appl. No.: 10/172,483

(22) Filed: Jun. 13, 2002

Related U.S. Application Data
(60) Provisional application No. 60/299,054, filed on Jun. 16, 2001.

(51) Int. Cl. G06F 15/173

(52) U.S. Cl. 709/226

(57) ABSTRACT

A data storage management system for an enterprise data storage system is provided for aggregating unused data storage space as a contiguous standardized data storage space on a distributed network system.

### CROSS-REFERENCE TO RELATED APPLICATION

This application claims the benefit of U.S. Provisional patent application serial No. 60/299,054 filed Jun. 16, 2001, which is incorporated herein by reference thereto.

### BACKGROUND

1. Technical Field

The present invention relates generally to archiving systems and more particularly a storage resource management system that recaptures unused disk storage space on enterprise personal computers for use in dedicated enterprise applications.

2. Background Art

Currently, all major enterprises (business entities) are trying to remain competitive by implementing new information technologies (IT) to help them drive their businesses. These information technologies range from the personal computers (PCs), which are being placed on every employee's desktop, down to their new web servers for providing information to their customers. Many of the requirements of these new technologies require the storage of more and more data.

The data storage market is actually expanding in many capacities because data is being accumulated at a tremendous rate. Not all of this data is needed on a day-to-day basis, but it is very difficult for enterprises to throw the data away.

A great deal of data is stored in “Primary Storage”, such as computer memory and hard disks, which are in every personal computer system. They tend to be the most expensive solution, but of course they are the fastest. They provide immediate access to data. But the actual hardware itself is expensive and must be multiplied by the number of personal computer systems in the enterprise.

The “enterprise” solution today is to spend lots more money and buy more storage facilities or “Secondary Storage”. Secondary Storage includes traditional backup/archive, media warehousing, management information system (MIS) data warehousing, and any other storage where usage requirements include: large (terabyte+) repositories, infrequent (i.e., daily/weekly) access, and latency tolerance.

The term “Secondary Storage” is introduced herein to underscore that different applications have different storage device performance requirements. There are currently two types of solutions for secondary storage applications: hard disk arrays and removable media.

Large hard disk arrays deliver performance in-line with the most demanding enterprise requirements and offer the advantages of on-line accessibility (timely access and lower operational costs). Mirrored Redundant Array of Independent/Inexpensive Disks (RAID) allows for the implementation of highly fault-tolerant solutions. However, these hard drives are extremely expensive and remain “solution overkill” in that their performance characteristics are unnecessarily excessive based on their high cost when compared to removable media solutions.

Removable media (tape and optical) are a lower cost alternative for providing adequate storage, but introduce both performance and organizational problems. With regard to performance for example, robotic tape/disc changers are expensive and even then have a limited capacity as to the number of removable storage containers that they can manipulate. With regard to organizational problems for example, tapes can be misplaced and natural disasters increase the probability of data loss. Further, tape drives have a total throughput about 1/1000 of the total throughput of standard PC hard drives.

For terabyte-large database queries, it is organizationally not feasible to extract and manage data stored across thousands of tapes or hundred of thousands of optical disks.

Thus, for removable media, performance is extremely slow but at a reduced cost. The redundancy/fault tolerance is very good with the exception that all removable storage media has a limited shelf-life and most enterprises lack logistical/procedural solutions redundancy in archiving, which will lead to serious problems and potential loss of substantial data over time.

Heretofore, no solution for high performance, enterprise level capacity, low cost storage has been believed to be possible to those skilled in the art.

### DISCLOSURE OF THE INVENTION

In analyzing and studying the above problems, it was discovered that one of the most interesting resources is the personal computer and its associated storage. For example in a major enterprise:

There may be 360,000 remotely managed PC's.

The average hard drive capacity is approximately 6.5 GB.

The average hard drive utilization is approximately 32%.

Whenever a PC is purchased, more storage space than immediately required is purchased so that the PC can actually last and remain functional within the business for a certain amount of time with the reasonable expectation that storage requirements will always go up.

Examining the increment at which corporate needs exceeds corporate purchases, there is a certain amount of empty space or “white space” where a hard drive on any individual PC has unused storage space. Taking the numbers of the major enterprise above into account, the enterprise has a theoretical capacity of more than 1.5 petabytes (1,500 terabytes) in unused individual PC disk storage space.

Now, within every enterprise today worldwide all of these PCs reside on networks, meaning each of these individual PCs is interconnected. So it was unexpectedly realized that, from an information technology manager's perspective, when they needed to buy storage space if a method could be found to reclaim that unused space on the PCs, the information technology manager could in essence get something for nothing. The storage space is purchased but is inaccessible. By being able to access the unused storage space, millions of dollars could be saved for a major enterprise.

However, there were at least two major obstacles.

First, there are major limitations imposed by the individual PCs. The storage space cannot be used in a way that makes the PC unusable for the individual user of the individual PC. That means that all of the unused storage space of the individual PC cannot be used. For example, without unused storage space, files could not be copied on to the hard drive or the PC would actually function slower because any operating system like Windows requires unused storage space to efficiently manage its memory.

Second, there are major limitations imposed by the networks. The networks are very important to every enterprise and keeping those networks functional is very, very important. The enterprise has configured the network to handle their existing applications and just like storage space, they always have to buy a little bit more bandwidth than they need because they cannot buy bandwidth every day. However, the excess bandwidth is extremely limited and cannot be used up for storage space related activities. Further, the amount of bandwidth available varies with the computer applications, which are in use during different times.

The present invention provides a data storage management system for aggregating unused data storage space on a distributed network system as a contiguous standardized data storage space.

The present invention further provides a storage management solution for secondary storage applications through intelligent management of unused PC hard drive capacity to create “virtual storage”, which may be aggregated and made available to centralized enterprise applications.

The present invention further provides a software-based storage management solution, aligned with secondary storage application requirements.

The present invention further provides a hardware-utilizing storage management solution, aligned with secondary storage application requirements.

The present invention further provides utilization of unused storage space on enterprise PC's, effectively bundling the distributed resources and sharing them as a single, contiguous, logical storage device on the enterprise network.

As a practical example, the above major enterprise has an amazing theoretical capacity of more than 1.5 petabytes (1,500 terabytes) in unused workstation disk space accessible by the present invention. By comparision, the major enterprise would normally require 75 terabytes of data for its normal operations and no more than 150 terabytes for expansion.

Assuming that the present invention always leaves 15% of a PC's disk space free, and that data will be stored redundantly across a minimum of four PC's: that still means an additional 330 terabytes worth of secondary storage, and millions of dollars in savings, for a major enterprise.

The above and additional advantages of the present invention will become apparent to those skilled in the art from a reading of the following detailed description when taken in conjunction with the accompanying drawings.

### BRIEF DESCRIPTION OF THE DRAWINGS

FIG. 1 is a an enterprise computer system incorporating the present invention;

FIG. 2 is a logical breakdown of a storage resource management system (SRMS) hardware/firmware/software of the present invention;

FIG. 3 is a first embodiment showing a high-level architecture incorporating a two peer configured SRMSs according to the present invention;

FIG. 4 is a second embodiment showing a high-level architecture incorporating a hierarchical configured SRMS and two peer configured SRMSs according to the present invention;

FIG. 5 is an exemplary structure/flow chart of a Write operation according to the present invention; and

FIG. 6 is an exemplary structure/flow chart of a Read operation according to the present invention.

### BEST MODE FOR CARRYING OUT THE INVENTION

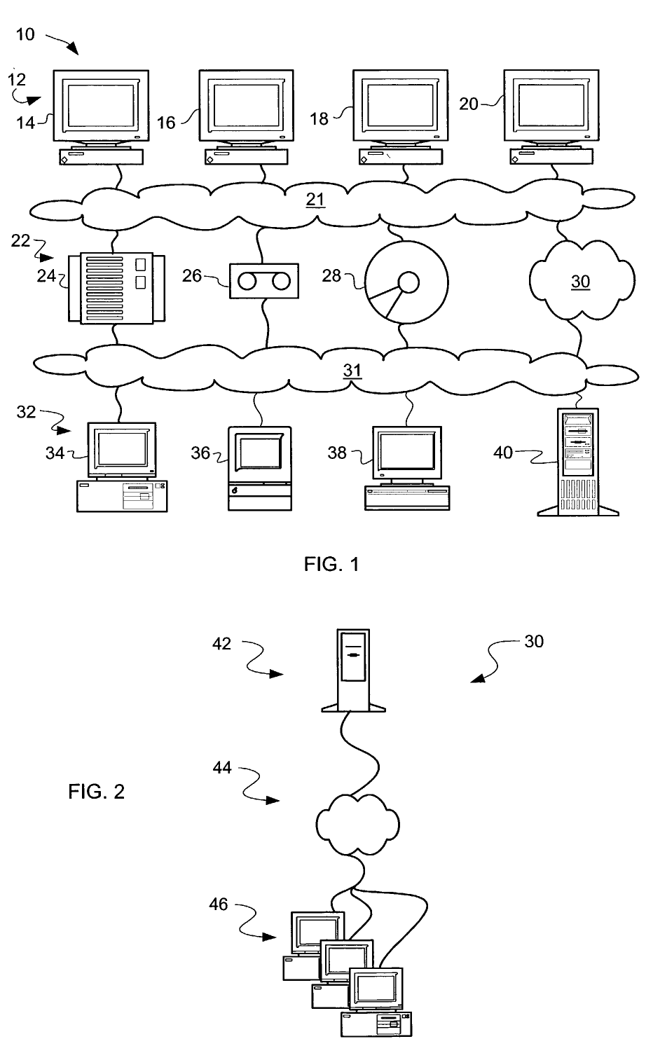

Referring now to FIG. 1, therein is shown an enterprise computer system 10 incorporating the present invention. The exemplary embodiment discloses a data storage management system for aggregating unused data storage space on a distributed network system as a contiguous standardized data storage space but it will be understood from the present disclosure that other unused or under utilized resources of an enterprise computer system may be utilized in realtime in accordance with the present invention.

The enterprise computer system 10 has a first level which includes external users or a plurality of enterprise applications (EA) 12, which are applications requiring resources in the system, such as storage resources. The EA 12 include email applications 14, world wide web applications 16, sales applications 18, customer care applications 20, etc. The email applications 14 range from the corporate e-mail solutions for sending and receiving e-mail, for store their in boxes on corporate servers, etc. The world wide web applications 16 provide users with e-commerce or information about the enterprise. The sales applications 18, for example, allow employees to create new contracts for customers, track orders, etc. The customer care applications 20 are where log complaints are logged, services are scheduled, etc.

The enterprise computer system 10 has connected to the first level by a network 21 a second level of a plurality of enterprise storage systems 22, such as hard disk arrays 24, tape drives 26, optical disks 28, etc. Each EA 12 has different qualities to the type of storage that they need to use. For example for e-mail, every enterprise has to set up policies, such as: how long are messages held for individual users; how large are mailboxes allowed to become before users must delete email; what is done with archives, mailboxes, etc.? Basically, the EA 12 is matched up with the plurality of enterprise storage systems 22 based on parameters such as the volume of data that is going to be stored, the type of usage characteristics (frequently or infrequently access), bandwidth required, etc. As examples, the hard disk arrays 24 are used for the fastest possible type of storage, tape drives 26 are often used for backup purposes, and the optical disks 28 are used for offline archival purposes.

This second level also contains the enterprise resource management system or storage resource management system (SRMS) 30 of the present invention, which is perceived by all the EAs 12 as just another of the plurality of enterprise storage systems 22. The SRMS 30 will be described in detail later.

The second level is connected by a network 31 to a third level of a plurality of enterprise personal computers 32, such as personal computer (PC) 34, Apple computers 36, other computers 38, servers 40, etc., having their own storage devices. It is expected that the plurality of enterprise personal computers 32 will contain about 500,000 PCs.

Referring now to FIG. 2, therein is shown a logical breakdown of the SRMS 30 hardware/software of the present invention. The SRMS 30 consists of three primary logic levels: a service tier 42; a middleware tier 44; and a client tier 46.

The service tier 42 appears in the second level of the plurality of enterprise storage systems 22 as a storage space for the EAs 12. When one of the EAs 12 requires data, the SRMS 30 initiates the retrieval of that data among the plurality of enterprise personal computers 32. The central intelligence of the SRMS 30 is a cluster of services residing upon one or more servers in the service tier 42. The SRMS 30 is easily scalable so it has different services that could reside on any number of servers depending on how much speed is required. These groups of aggregated services collectively and logically make up the service tier 42.

The middleware tier 44 is responsible for moving the bits of data across the network in an intelligent fashion. The middleware tier 44 is sensitive to the enterprise bandwidth requirements and ensures that packets of data arrive securely to and from the plurality of enterprise personal computers 32 to the service tier 42.

The client tier 46 exists in all of the plurality of enterprise personal computers 32 that are going to be used to recapture the unused disk space and brokers unused disk space by intelligently managing blocks of data sent to and from the service tier 42. The client tier 46 serves several functions, such as reserving a configurable portion of available storage space and reacting dynamically to the changing local environment. As local disk-space is used by local applications, the client tier 46 will relinquish the reserved storage space. As local storage space becomes free, the client tier 46 gradually assumes more of the storage space. For example, if the service tier 42 needs to write a certain amount of data, the client tier 46 determines the best one of the plurality of enterprise personal computers 32 for this particular amount of data to be stored based on its usage requirements.

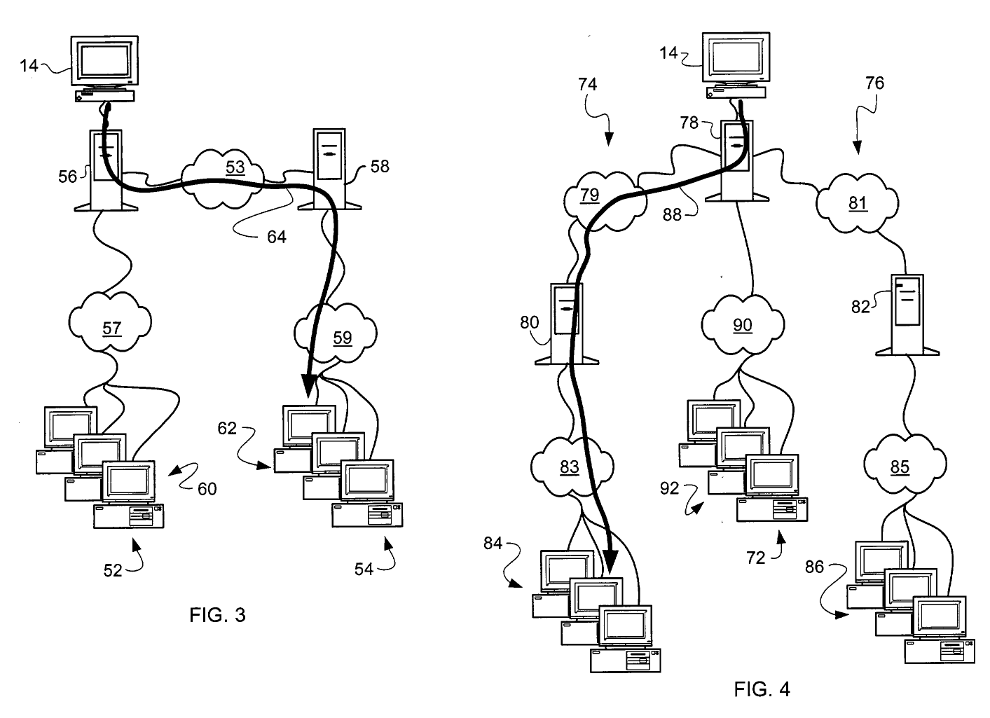

Referring now to FIG. 3, therein is shown a first embodiment showing a high-level architecture 50 incorporating two peer configured SRMS 52 and 54 interconnected by a network 53 where there are two enterprise applications, such as the email applications 14 and the world wide web applications 16 using aggregated data across the two peer configured SRMS 52 and 54.

In the SRMS 52, the email application 14 is configured to use a local storage system 56 but the SRMS 52 knows the data is on a remote SRMS storage system 58. When the email application 14 goes to access data on the local storage system 56, the local storage system 56 would know the cross-reference for data that actually resides in the remote SRMS storage system 58 and send the request to the remote SRMS storage system 58 and it will automatically retrieve data and place it in the local storage system 56. Each of the two peer configured SRMS 52 and 54 will be respectively connected by networks 57 and 59 to at least 2,000, and more probably about 8,000 enterprise personal computers, and their respective data storage resources or disk drives for a total about 16,000 enterprise personal computers 60 and 62. The access path from the email application 14 to the SRMS storage resources in the enterprise personal computers 62 is along an arrow 64.

Referring now to FIG. 4, therein is shown a second embodiment showing a high-level architecture 70 incorporating a hierarchical configured SRMS 72 and two peer configured SRMS 74 and 76, and where there is one enterprise application, such as the email applications 14 using aggregated data across the hierarchical/peer SRMS.

In the SRMS 72, the email application 14 is configured to use a local storage system 78 but the local storage system 78 knows the data is on a remote SRMS storage system 80. When the email application 14 goes to access data on the local storage system 78, the local storage system 78 would know the cross-reference for data that actually resides in the SRMS storage system 80 and send the request to the SRMS storage system 80 and it will automatically retrieve data and place it in the local storage system 78. The access path from the email application 14 to the SRMS storage in enterprise personal computers 84 is along an arrow 88. The hierarchical SRMS 72 is connected by networks 79, 81, and 90 to about 24,000 enterprise personal computers 92 and their respective disk drives.

As would be evident from the above, there is virtually no limit to the number of SRMS, which could be connected together or to the number of data storage resources, which could be connected together and accessed as a single, contiguous, standard storage volume or storage space..

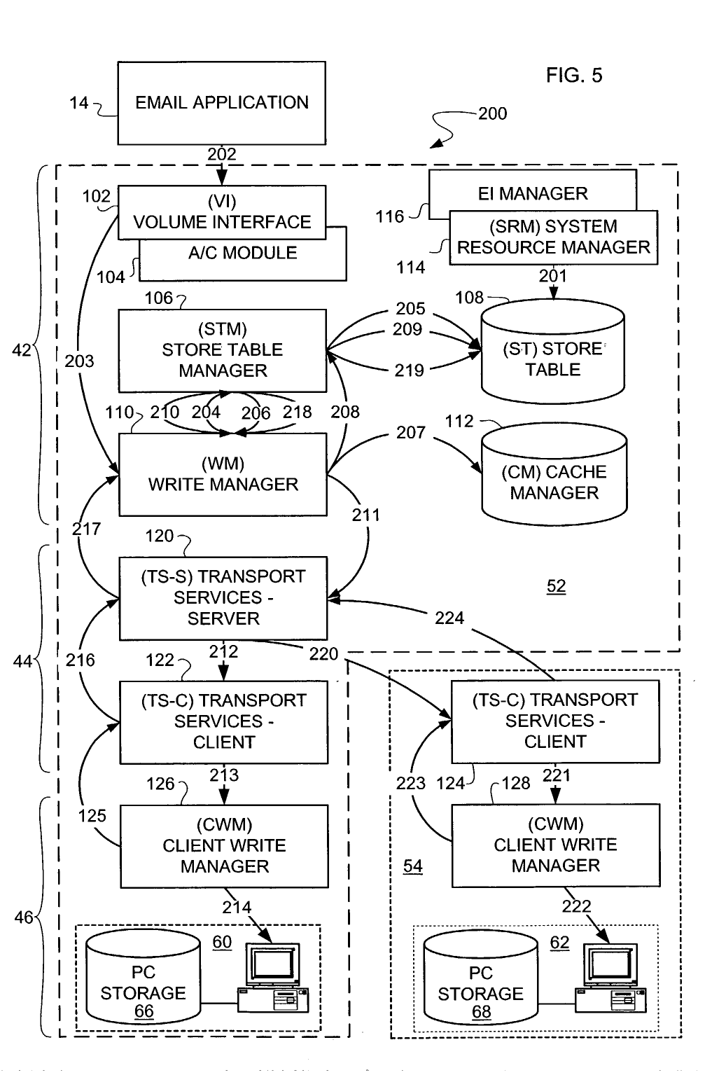

Referring now to FIG. 5, therein is shown an exemplary structure/flow chart 200 of the detailed structure and Write operation of the high-level architecture 50 of FIG. 3. As a point of reference, the email application 14 is shown connected to the service tier 42 of the SRMS 52. The service tier 42 is connected to the middleware tier 44 of the SRMS 52 and 54. The middle ware tier 44 of the SRMS 52 and 54 are respectively connected to the enterprise personal computers 60 and 62, which have respective individual PC storage systems 66 and 68.

The exemplary structure/flow chart 200 shows the service tier 42 includes a volume interface (VI) 102. The VI 102 provides a volume interface, or standardized means of access to industry-standard resources, and is the connection between the SRMS 52 as a storage space (or storage volume) and the outside world. This is to say that the aggregated storage will be presented to the email application 14, for example, via one or more technical interfaces. The VI 102 provides a layer of abstraction between external systems read/write requests and the internal the SRMS File System. The VI 102 processes store table metadata and provides virtualized file system data in the native format of any supported directory-read command as will later be explained.

There are several alternate interface techniques that include:

API—A proprietary Application Program Interface (API) can be used by enterprise applications to manage standard read and write functions. This defines a predetermined protocol (UDP, OLE, IP socket connections and RPC, etc.) for the environment and then a series of structured command and procedure calls with which an enterprise application could read and write streams of data to the storage space. This approach is efficient for applications like the back up of known storage spaces.

Object Interface—Entails the creation of accessible “storage objects” within any of the major distributed object application frameworks. The Object Interface (OI) approach entails choosing an object-oriented framework (CORBA, J2EE, DCOM, .NET, etc.) and implementing the read/write components as objects within such a framework. Creating such objects can be labor intensive, but the results can have several advantages over any of the other VI methods, namely: Fault tolerance, latency tolerance, scalability, peer-to-peer application compatibility, etc. As a trend, enterprise application development is moving towards object oriented distributed architectures.

OS Level Interface—This approach exposes the storage space to an Operating System (OS) as a traditional storage device (i.e., hard drive). As an example, this OS Interface software is what, under Windows, is referred to as a Virtual Device Driver. It creates a true Virtual Storage Device from the aggregated storage, controlled by the SRMS 30, appearing as a hard drive to all users and applications. This device driver would essentially pass the simple read and write requests (coming from the OS) to COM-interfaces (Active Template Library), which in turn provide the “hook” for the core services, which are a collection of server-based logical components that manage the end-to-end read and write processes. Importantly, the Store Table (see below) metadata must be used to assemble the link between the SRMS data blocks and the appropriate files and directories in an emulated file system format. The device driver provides the coherency of this virtual file system for the given OS and provides a degree of platform independence.

NAS—This approach front-ends the SRMS storage space with a Network Attached Storage (NAS) device—for broad support of network file systems and transparent usage by enterprise applications and remote users alike. The following excerpt was taken from Sun Microsystem's white paper on NAS:

NAS provides security and performs all file and storage services through standard network protocols, using TCP/IP for data transfer, Ethernet and Gigabit Ethernet for media access, and CIFS, http, and NFS for remote file service. In addition, NAS can serve both UNIX and Microsoft Windows users seamlessly, sharing the same data between the different architectures. For client users, NAS is the technology of choice for providing storage with unencumbered access to files.

Although NAS trades some performance for manageability and simplicity, it is by no means a lazy technology. Gigabit Ethernet allows NAS to scale to high performance and low latency, making it possible to support a myriad of clients through a single interface. Many NAS devices support multiple interfaces and can support multiple networks at the same time. As networks evolve, gain speed, and achieve latency (connection speed between nodes) that approaches locally attached latency, NAS will become a real option for applications that demand high performance.

For example in one mode, the service tier 42 provides a device driver interface, emulating one or more standard hard drives under Windows 2000. This device driver handles all read/write commands coming from the applications.

Behind the VI 102, several critical functions perform the “virtualization” of the distributed PC storage:

Disassemble incoming (write) file data into network-optimized data-blocks.

Reassemble incoming (read) block data and stream files back to OS read commands.

Maintain/manage local cache and buffering functions for read and write functions.

Maintain/manage a “Store Table” which has a complete record of the physical location (remote PC resources; e.g., hard disk space) and ID of all stored the SRMS data blocks.

Manage all non-local read and write operations (to and from the PC Clients).

The server components will use:

Mirrored Redundant Array of Independent/Inexpensive Disks (RAID)-like mirroring techniques to ensure that each block of data is secured in a highly redundant fashion.

RAID-like striping techniques, breaking files into smaller blocks and distributing them across the plurality of enterprise personal computers 32 so that parallel read and write functions can boost throughput to theoretical speeds of 1 Gb/sec.

Modules to maintain current and historical statistics on remote resources to ensure that read and write algorithms optimize fault tolerance and performance.

The middleware tier 44 as previously explained is responsible for moving the bits of data across the network in an intelligent fashion. The middleware tier 44 is sensitive to the enterprise bandwidth requirements and ensures that packets of data arrive securely to and from the client tier 46 to the service tier 42. The network usage is optimized in two key fashions:

Maximizing performance through choosing the clients (as sources or repositories) that offer the lowest latency and greatest throughput.

Minimizing network abuse through the use of compression, multicasting and throttling when necessary.

The middleware tier 44 also utilizes encryption and authentication techniques to ensure that data moving across the network is secure.

The client tier 46 exists in all of the plurality of enterprise personal computers 32 that are going to be used to recapture the unused disk space and brokers unused disk space by intelligently managing blocks of data sent to and from the service tier 42. The client tier 46 serves several functions, such as reserving a configurable portion of available storage space and reacting dynamically to the changing local environment. As local disk-space is used by local applications, the client tier 46 will relinquish the reserved storage space. As local storage space becomes free, the client tier 46 gradually assumes more of the storage space. For example, if the service tier 42 needs to write a certain amount of data, the client tier 46 determines the best one of the plurality of enterprise personal computers 32 for this particular amount of data to be stored based on its usage requirements.

Alternatively, administrators can configure the client to “lock” a set amount of the hard drive's capacity taking up vital statistics required to determine when this device will be most optimally used.

The client tier 46 also monitors historical and current computer usage, workstation availability and other relevant data. This data is tracked over time and plays a valuable role in determining which blocks of data should be stored on which client resource. The client tier 46 gathers the data and one or more of the plurality of enterprise personal computers 32 perform the necessary computations during the otherwise idle time of the plurality of enterprise personal computers 32. For example, the PC 34 can determine: when is it usually on; has its actual Internet Protocol address changed; how much more disk space does it have; when is it usually not in use; etc.

The client tier 46 is also responsible for propagating mirrored data blocks to secondary client tier targets as needed. This decreases server-side bottlenecks, while avoiding the necessity for multicast network configuration. Further, the client tier 46 will also ensure that data stored locally is secure from local or unauthorized remote access.

The client tier 46 is software implemented and can be downloaded through a network connection. Further, the client tier 46 can update its own code automatically.

The exemplary structure/flow chart 200 is of a backup program taking a routine archive of a mail system. An enterprise e-mail system needs to remove all files into a secondary storage where access is required but not frequently. As a result, theoretically a couple of terabytes worth of data will be stored in the SRMS 52 and/or SRMS 54. The email application 14 believes that the SRMS 52 or 54 is of course a standard normal hard drive or disk array so it initiates a write command just like it would for any local storage space.

More specifically, the email application 14 has all the aggregated enterprise personal computer storage space presented to it through the VI 102.

Behind the VI 102 is an Administrative/Configuration (A/C) Module 104, which controls customization of the SRMS by handling any necessary presentation (enterprise application interface) and automation involving developer variables. Such variables could include, for example, the SRMS Block size, key run-time variables, etc.

The A/C Module 104 also handles any presentation and automation necessary to provide administrators with the ability to set key system configuration data. Such data could include, for example:

Network usage rules (throttles, segment information, etc.)

Space usage rules (percent of available space, fixed space, minimum/maximums, etc.)

Redundancy settings

Striping settings

Alerts/Error handling parameters

Subordinate/Slave settings for hierarchical implementations

The A/C Module 104 also handles any presentation and automation necessary to provide administrators with the ability to set key client (client PC) configuration data as well as to perform key administration relevant tasks. Such tasks include:

Deletion of data

“Partitioning” of the SRMS storage spaces

Importing storage resource (client PC) remote administration data

Recovery management

The A/C Module 104 also provides all necessary user-reporting functions. Such reports could include, for example:

Total Storage vs. Storage Available

Usage Statistics (Frequency of use)

Performance Statistics (Access Times, Throughput, etc.)

Resource Availability (PC's availability—individually and statistically)

A resource table manager or Store Table Manager (STM) 106 provide stores table management logic, or logic that determines the optimal place for the storage or retrieval of data is in the service tier 42 and operates in conjunction with a resource table or Store Table (ST) 108. The ST 108 is an optimized repository for the SRMSs metadata. In FIG. 5, the ST 108 is a write database. The STM 106:

manages and shares all relevant data-location knowledge.

manages local and remote copies of the Store Table data.

keeps a real-time record of the location of all locally cached blocks and files as well as all remotely stored blocks.

maintains and communicates Lock status for file cache, block cache and remote blocks.

determines whether read/write commands must be passed-through to subordinate the SRMS instances.

determines the optimal resources for all write requests, selecting a prioritized list of resources for each block requiring inbound shipping and interacts with the Resource Manager (see below) in order to make this determination.

uses RAID-like mirroring techniques to ensure that each block of data is secured in a highly redundant fashion.

uses RAID-like striping techniques, to ensure that blocks are distributed across multiple client PC's, assuring that parallel read and write functions can maximize data throughput.

may store extracts from the Resource Manager data within the Store Table itself. The STM 106 is extremely fault tolerant.

A Write Manager (WM) 110 is in the service tier 42 and:

handles all write requests coming through the VI 102, subsequently coordinating all necessary logic and components to ensure end-to-end management of the write function.

handles parallel write requests synchronously or asynchronously as required.

manages critical errors that must be reported to the VI 102 and A/C such as: inadequate space, time out, etc.

locks data blocks for all pending write operations to prevent errors when multiple the SRMS Using Applications attempt to write to the same file simultaneously.

manages Delete functions.

caches files locally.

splits files into the SRMS Block segments, caching the blocks locally.

queries the STM 106 for Primary and Secondary block storage location targets for each block.

initiates “outbound shipping” of each block to it's designated primary storage location. Corresponding secondary storage location data will be passed to the Transport Services modules as well.

handles any transport errors reported by the Transport Service modules, requesting new target storage locations (primary or secondary as necessary) until the entire read process is complete.

initiates the Store Table update (via the STM 106) upon completion of all write operations.

A Cache Manager (CM) 112 is associated with the WM 110 and the STM 106 in the service tier 42. The CM 112:

purges the most antiquated items from local file cache and local block cache in accordance with available disk space and any set configuration parameters.

informs the Store Table Manager of deletions from local file and block cache prior to deleting the file.

A System Resource Manager (SRM) 114 provides storage resource management logic. The SRM 114 is also in the service tier 42 and constantly operates in the background. The SRM 114:

constantly updates key resource (client PC's) attributes and statistics based on inbound (client-sent) data within the ST 108.

performs any necessary calculation on the resource data to enable rapid calculation.

supplies the STM 106 with relevant and performance optimized extracts of client resource data to facilitate storage resource selection.

manages updates of the SRMS client configuration parameters and software.

manages remote control (Wake On LAN) functions required for client resources.

handles errors relating to client availability/performance and interacting with the A/C Module 104 as necessary.

An External Interface (El) Manager 116 is behind the SRM 114 for integration with different network/inventory management tools. These tools can have some or all the following attributes that are relevant to the SRMS:

Inventory Data—Full inventory of all of the plurality of enterprise personal computers 32 including physical location descriptions, neighboring telephone extensions, etc.

Network Topology Data—Provides key information concerning segmentation, bandwidth, network traffic, etc.

Remote Management Capabilities—Distribute and install client software on the plurality of enterprise personal computers 32.

In the middleware tier 44 are Transport (communication) Services, which are responsible for facilitating efficient and successful communication and transport of data between the distributed the SRMS components. Transport Services have software that resides within both the client and server layers of the SRMS. Physically, the mechanisms for the SRMS 52 for providing a Transport Services-Server (TS-S) 120 are in the SRMS storage system 56 with a Transport Services-Client (TS-C) 122 in the enterprise personal computers 60 on the other side of the network 57. Physically, the mechanisms for the SRMS 54 for providing a Transport Services-Client (TS-C) 124 are also in the enterprise personal computers 62 on the other side of the networks 53 and 59 from the TS-S 120 of the SRMS 52.

Although traditional networking protocols are designed to cover the basic functionality, the SRMS is designed such that this communications layer is implemented modularly to facilitate augmentation. The Transport Services can use the existing network protocols (TCP/IP) pr pre-specified framework communications facilities (transaction services, fault tolerant-brokering, etc.) in the native the SRMS implementation platforms (COM+, .NET, J2EE).

The Transport Services:

facilitate the SRMS-specific error handling controls.

handle Core-based read/write error handling by:

providing receipts for successful read/writes.

attempting to resolve unsuccessful read/write requests by initiating duplicate requests with secondary PC resources.

informing requesting components of failures and providing relevant error codes/information.

utilize its client components to complete client-to-client mirroring (Side Loading) of data blocks as instructed by the Core Services Write Manager so as to reduce server CPU and bandwidth load.

require ID/Signatures from any components accessing this service layer.

encrypt data for storage and transport if this level of security is desired.

decrypt data for retrieval and transport if this level of security is desired.

provide a throttle because the Transport Services are traffic-sensitive so limiting the SRMS bandwidth consumption on over-burdened network segments is required.

provide throttle control on both Server and Client elements of the Transport Services.

compress data for optimization of transport in situations where CPU capacity is greater than network capacity.

initiate read commands on multiple resources simultaneously, “killing” the less performant of the responding resources in circumstances where the Transport Services is provided a prioritized list of target PC resources for data retrieval.

exploit any Quality of Service features present on the enterprise network if significant performance benefits can be achieved from such measures.

A Client Write Manager (CWM) 126 and a CWM 128 respectively for the SRMS 52 and 54 in the client tier 46 interact with and have the exclusive focus of receiving and storing data blocks sent from the modules in the service tier 42. The CWM 126 and 128 support basic start, stop and error handling functions.

In the client tier 46 are the client level portions (not shown) of the A/C Module 104 and the SRM 114. The client level portion of the A/C Module 104:

handles all non-read/write and non-stat related functions called upon by the SRMS server.

adjusts disk space usage dynamically with any change in disk space usage configuration settings.

adjusts the SRMS Client activity dynamically with any change in CPU usage configuration settings.

provides any client user interface (UI) services necessary (if any) for the client user.

utilizes hooks in Win32 messaging to monitor commands to shut down Windows and ensures:

that the client user is (optionally-by configuration) prompted to confirm shutdown despite enterprise application the SRMS, and

that the client user performs an orderly shut-down of the SRMS, informing the server of shut-down.

The client level portion of the SRM 114:

collects and stores relevant data concerning: client availability, user profile (reacts to the SRMS requests, uses soft shutdown, etc.), network conditions, CPU usage (historical and averages), etc.

performs any calculations possible to provide the server with “refined” statistical data: client-side calculations reduce server-side bandwidth and CPU requirements.

“packages and ships” statistical data at pre-determined times, thresholds and server-side requests.

During operation in step 201, the SRM 114 updates the ST 108 at scheduled intervals, providing current resource availability and performance statistics involving all of the resources on the network, such as the enterprise personal computers 60 and 62. As it collects data from all of those clients that have been distributed on thousands of personal computers, it is updating the ST 108, which essentially is a metadata database where the locations of files within the storage space are stored.

The following is an example of a backup program taking routine archive of a mail system. A corporate e-mail system needs to remove all files into a secondary storage zone where rapid access is desired but the access will be infrequent. Theoretically, a couple of terabytes worth of data will be moved into SRMS storage. The email application 14 views that SRMS storage as the standard normal hard drive or disk array so it goes ahead and initiates a Write command just like it would for any external disk array device.

In step 202, the email application 14 initiates a Write command and passes the Write command to the VI 102.

In step 203, the VI 102 translates the Write command into the internal SRMS File System format for the WM 110.

In step 204, the WM 110 queries the STM 106 for write permission.

In step 205, the STM 106 checks the ST 108 permission settings for a target directory/space.

In step 206, the STM 106 grants WM 110 write permission. (If permission is denied: WM 110 must inform VI 102 and provide error codes). EXCEPTION: In multi-the SRMS environments, the STM 106 could designate the SRMS instance ID for target write destination.

In step 207, the WM 110 begins caching the files locally and begins splitting the files into Data Blocks, caching blocks locally.

In step 208, as soon as the first blocks are cached the WM 110 queries the STM 106 for each Data Blocks' target list. (This process is repeated for all new blocks)

In step 209, the STM 106 queries the ST 108 for resource data and calculates the current optimal Resource ID's for storage targets.

In step 210, the STM 106 provides the WM 110 with write instructions, listing all the Resource ID's for storage.

In step 211, the WM 110 sends block data and block target information to the TS-S 120 for storage.

In step 212, the TS-S 120 passes block data and block metadata to TS-C 122.

In step 213, the TS-C 122 delivers block data to the CWM 126.

In step 214, the CWM 126 writes data through the enterprise personal computer 60 to the PC's storage system 66.

In step 215, the CWM 126 informs TS-C 122 of success of the Write.

In step 216, the TS-C 122 informs the TS-S of success.

In step 217, the TS-S informs the WM 110 of success.

In step 218, the WM 110 informs the STM 106 of success.

In step 219, the STM 106 updates the ST 108 to reflect the location of the stored block.

In step 220, the TS-S 120 passes block data and block metadata to the next TS-C in target list, such as TS-C 124.

In step 221, the TS-C 124 delivers block data to the CWM 128.

In step 222, the CWM 128 writes data through the enterprise personal computer 62 to the PC's storage system 68.

In step 223, the CWM 128 informs TS-C 124 of success of the Write.

In step 224, the TS-C124 informs the TS-S 120 of success.

The SRMS 52 proceeds up to update the ST 108 and proceeds down to pass block data and block metadata to the next TS-C in the target list until all the mail files have been stored.

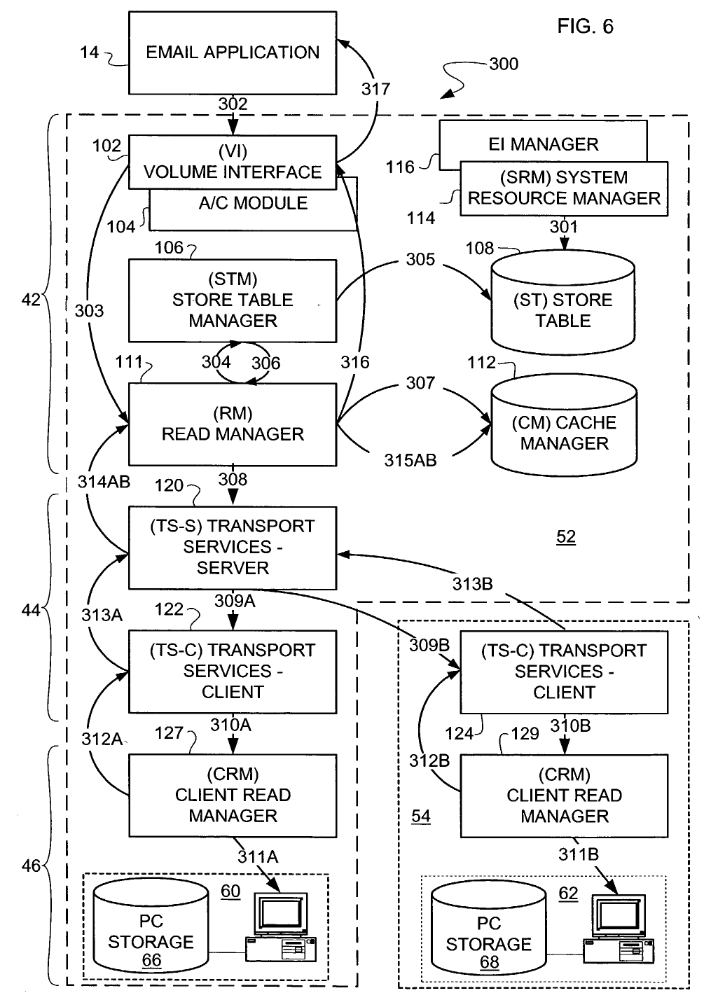

Referring now to FIG. 6, therein is shown an exemplary structure/flow chart 300 of the detailed structure and Read operation of the high-level architecture 50 of FIG. 3. The majority of the elements are the same as in FIG. 5 with the exception that the service tier 42 uses a Read Manager (RM) 111 in place of the WM 110 and the client tier 46 uses Client Read Managers (CRMs) 127 and 129 in place of CWMs 126 and 128.

The RM 111:

handles all read requests coming through the VI 102, subsequently coordinating all necessary logic and components to ensure end-to-end management from read request to data delivery.

handles parallel read requests synchronously or asynchronously as required.

manages critical read errors that must be reported to the VI 102 and A/C Module 104.

queries the STM 106 to determine the optimal resources (client PC's) as potential sources for the target data.

reads the file directly from local file cache if file cache is designated as a source for the target data.

utilizes any data blocks that are cached locally if the block cache is designated as a source for the target data.

initiates the “inbound-shipping” (via Transport Services) of each required block.

handles any transport errors reported by the Transport Service modules.

assembles incoming or locally cached blocks in contiguous, locally cached files as appropriate. The blocks are not expected to arrive in “linear” order.

The CRMs 127 and 129 have the exclusive focus of retrieving and “shipping” data requested data blocks to the SRMS Services layer in a timely and efficient manner support basic start, stop, and error handling function.

During operation in step 301, the SRM 114 updates the ST 108 at scheduled intervals, providing current resource availability and performance statistics involving all of the resources on the network, such as the enterprise personal computers 60 and 62.

The following is an example of a backup program retrieving portions of the archive of a mail system. A corporate e-mail system needs to have rapid access from the storage space. The email application 14 views the several terabytes of SRMS storage as its standard normal hard drive or disk array so it goes ahead and initiates a Read command just like it would for any external disk array device.

In step 302, the email application 14 initiates a Read command and passes the Read command to the VI 102.

In step 303, the VI 102 translates the Write command into the internal SRMS File System format for the RM 111.

In step 304, the RM 111 queries the STM 106 for write permission.

In step 305, the STM 106 checks the ST 108 for the permission settings for the target directory/space and determines optimal target PC storage for file retrieval.

In step 306, the STM 106 grants the RM 111 Read permission. (If permission is denied: the RM 111 must inform the VI 102 and provide error codes) and provides target Resource ID's for each required block. An exception is if files or blocks are located in cache, or in multi-the SRMS environments, the STM 106 could designate the cache location or the SRMS instance ID for target Read destination.

In step 307, optionally, the RM 111 retrieves files or blocks from the cache.

In step 308, the RM 111 sends block and block target information to TS-S 120 for retrieval.

In step 309A and 309B, the TS-S 120 passes the Read command and block metadata to TS-C 122 and 124. The process is massively parallel-additional blocks are read simultaneously.

In step 310A and 310B, the TS-C 122 and 124 respectively deliver in parallel the Read command and block metadata to CRMs 127 and 129.

In step 311A and 311B, the CRMs 127 and 129 respectively read data in parallel through the enterprise personal computers 60 and 62 from the PC's storage system 66 and 68.

In step 312A and 312B, the CRMs 127 and 129 pass block data and block metadata to the TS-C 122 and 124.

In step 313A and 313B, the TS-C 122 and 124 passes block data and block metadata to the TS-S 120.

In step 314AB, the TS-S 120 passes block data and block metadata to the RM 111.

In step 315AB, the RM 111 stores the block in local cache and begins reconstructing file locally by assembling blocks sequentially.

In step 316, the RM 111 streams the file in the internal the SRMS File System format to the VI 102.

In step 317, the VI 102 translates and streams the files to the email application 14.

It will be evident from reading the above that the WM 110 and the RM 111 can be a single Manager, such as a Read/Write Manager (RWM) and, similarly, that the CWMs 126 and 128 and the CRMs 127 and 129 can be a single Manager, such as a Client Read/Write Manager (CWRM). These managers include both logic and control capabilities.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the spirit and scope of the included claims. All matters hither-to-fore set forth herein or shown in the accompanying drawings are to be interpreted in an illustrative and non-limiting sense.

The invention claimed is:

1. A method for enterprise resource management for a plurality of unused resources on a network, comprising:
communicating with the plurality of unused resources;
aggregating the plurality of unused resources; and
using an aggregation of the plurality of unused resources as a contiguous local resource.

2. The method of enterprise resource management as claimed in claim 1 including:
communicating with a plurality of portions of contiguous information across the plurality of unused resources.

3. The method of enterprise resource management as claimed in claim 1 including:
communicating in parallel with a plurality of portions of contiguous information across the plurality of unused resources.

4. The method of enterprise resource management as claimed in claim 1 including:
optimizing the communicating with a plurality of portions of contiguous information across the plurality of unused resources.

5. The method of enterprise resource management as claimed in claim 1 including:
deconstructing a plurality of portions of contiguous information to the plurality of unused resources;
reconstructing the plurality of portions of contiguous information from the plurality of unused resources; and
communicating in parallel with the plurality of portions of contiguous information across the plurality of unused resources.

6. A method for enterprise resource management for an enterprise application and a plurality of unused resources on a network, comprising:
communicating with the plurality of unused resources;
aggregating the plurality of unused resources; and
communicating with the enterprise application as a local resource having an aggregation of the plurality of unused resources.

7. The method of enterprise resource management as claimed in claim 6 including:
storing contiguous information across the plurality of unused resources in a plurality of portions of information.

8. The method of enterprise resource management as claimed in claim 6 including:
storing contiguous information in parallel across the plurality of unused resources in a plurality of portions of information.

9. The method of enterprise resource management as claimed in claim 6 including:
optimizing the storage of contiguous information across the plurality of unused resources in a plurality of portions of information.

10. The method of enterprise resource management as claimed in claim 6 including:
retrieving contiguous information across the plurality of unused resources.

11. The method of enterprise resource management as claimed in claim 6 including:
retrieving information across the plurality of unused resources in parallel portions of information; and
reconstructing retrieved parallel portions of information as contiguous information.

12. The method of enterprise resource management as claimed in claim 6 including:
updating the availability of the plurality of unused resources.

13. The method of enterprise resource management as claimed in claim 6 including:
providing a second plurality of unused resources in parallel on the network; and
aggregating the aggregation of the plurality of unused resources and the aggregation of the second plurality of unused resources.

14. The method of enterprise resource management as claimed in claim 6 including:
providing a second plurality of unused resources in a hierarchy on the network; and
aggregating an aggregation of the plurality of unused resources and an aggregation of the second plurality of unused resources.

15. The method of enterprise resource management as claimed in claim 6 including:
providing security for the communicating with a group consisting of the plurality of unused resources, the plurality of enterprise applications, and a combination thereof.

16. The method of enterprise, resource management as claimed in claim 6 including:
providing customization for the aggregating of the plurality of unused resources.

17. The method of enterprise resource management as claimed in claim 6 including:
controlling operation of the plurality of unused resources.

18. The method of enterprise resource management as claimed in claim 6 including:
providing for integration of a network management tool.

19. The method of enterprise resource management as claimed in claim 6 including:
providing for error handling for the communicating with a group consisting of the plurality of unused resources, the plurality of enterprise applications, and a combination thereof.

20. The method of enterprise resource management as claimed in claim 6 including:
providing customization for the aggregating of the plurality of unused resources.

21. A method of enterprise resource management for an enterprise computer system having an enterprise application and plurality of client computers having resources, comprising:
updating current resource availability of resources on the network by a resource manager;
transmitting information from the enterprise application using a read/write manager;
communicating across the network a first portion of the information between the read/write manager to a first client computer having a first resource;
using the first resource for the first portion of the information;
communicating across the network a second portion of the information between the read/write manager to a second client computer having a second resource; and
using the second resource for the second portion of the information.

22. The method of enterprise resource management as claimed in claim 21
translating information from the enterprise application to the read/write manager through a volume interface whereby the enterprise application sees the first and second resources as an enterprise application local resource.

23. The method of enterprise resource management as claimed in claim 21 splitting the information into blocks in the read/write manager.

24. The method of enterprise resource management as claimed in claim 21
splitting the information into blocks in the read/write manager; and
determining optimal placement of the blocks in the first and second resources by an resource table manager.

25. The method of enterprise resource management as claimed in claim 21
transporting the information across the network using a server transport service and a plurality of client transport services.

26. The method of enterprise resource management as claimed in claim 21
updating at scheduled intervals to provide the current resources availability and performance statistics of resources on the network.

27. The method of enterprise resource management as claimed in claim 21
providing a second enterprise computer system and a further client computer having a further resource; and
indicating the second enterprise computer system in the resource table manager; and
communicating across the network a further portion of the information between the read/write manager to the further client computer having the further resource; and
using the further resource for the further portion of the information.

28. The method of enterprise resource management as claimed in claim 21 using mirrored redundant array of independent/inexpensive disk-like mirroring techniques by the volume interface to ensure that information is secured in a highly redundant fashion in the first and second resources.

29. The method of enterprise resource management as claimed in claim 21
using mirrored redundant array of independent/inexpensive disk-like striping techniques by the resource table manager to ensure that information is distributed across the first and second resources to maximize parallel information communication.

30. A method of enterprise resource management for an enterprise application on a network comprising:
updating at scheduled intervals to provide current resource availability and performance statistics of resources on the network from a resource manager to a resource table;
initializing a Write command in the enterprise application in an enterprise application format;
sending the Write command from the enterprise application to a volume interface;
translating the Write command in the volume interface from the enterprise application format into an internal resource management system File System format for a write manager;
querying for write permission from the write manager to a resource table manager;
checking for permission settings for a target directory/space from the resource table manager to a resource table;
granting write permission from the resource table manager to the write manager;
caching files by the write manager;
splitting the files into Data Blocks by the write manager;
querying for each Data Blocks' target list from the write manager to the resource table manager;
querying for resource data from the resource table manager to the resource table;
calculation of current optimal Resource identifications for storage targets by the resource table manager;
providing Write instructions, listing all Resource identifications for processing from the resource table manager to the write manager;
sending block data and block target information for storage from the write manager to a server transport service;
passing block data and block metadata from the server transport service to a client transport service;
delivering block data from the client transport service to the client write manager;
writing data from the client write manager through an enterprise personal computer to a personal computer storage system;
informing of the success of the Write from the client write manager to the client transport service;
informing of the success of the Write from the client transport service to the server transport service;
informing of the success of the Write from the server transport service to the write manager;
informing of the success of the Write from the write manager to the resource table manager;
updating the location of the stored block from the resource table manager to the resource table;
passing block data and block metadata from the server transport service to a second client transport service in target list;
delivering block data from the client transport service to the client write manager;
writing data from the client write manager through a second enterprise personal computer to a second personal computer storage system;
informing of the success of the Write from the client write manager to the second client transport service; and
informing of the success of the Write from the second client transport service to the server transport service.

31. A method of enterprise resource management for an enterprise computer system having an enterprise application and plurality of client computers having resources with information, comprising:
updating current resource availability of resources on the network by a resource manager;
requesting the information by the enterprise application using a read/write manager;
communicating across the network requesting the information between the read/write manager to a first and second client computer having respective first and second resources having respective first and second portions of the information;
providing the first and second portions of the information in parallel;
communicating across the network the first and. second portions of the information in parallel; and
reconstructing the first and second portions of the information into the information in the read/write manager; and
providing the information to the enterprise application.

32. The method of enterprise resource management as claimed in claim 31
translating information from the read/write manager to the enterprise application through a volume interface whereby the enterprise application sees the first and second resources as an enterprise application local resource.

33. The method of enterprise resource management as claimed in claim 31
determining optimal target resource for the information retrieval by the resource table manager.

34. The method of enterprise resource management as claimed in claim 31
determining optimal target resource for the information retrieval by the resource table manager; and
using the optimal target resource determination for the information retrieval by the read/write manager.

35. The method of enterprise resource management as claimed in claim 31
transporting information across the network using a server transport service and a plurality of client transport services operating in parallel.

36. The method of enterprise resource management as claimed in claim 31
updating at scheduled intervals to provide the current resources availability and performance statistics of resources on the network.

37. The method of enterprise resource management as claimed in claim 31
providing a second enterprise computer system and a further client computer having a further resource having a further portion of the information; and
determining the second enterprise computer system in the resource table manager as a further optimal target resource; and
communicating across the network the further portion of the information between the read/write manager from the further client computer having the further resource.

38. The method of enterprise resource management as claimed in claim 31 retrieving information using mirrored redundant array of independent/inexpensive disk-like mirroring techniques by the resource table manager.

39. The method of enterprise resource management as claimed in claim 31
retrieving information using mirrored redundant array of independent/inexpensive disk-like striping techniques by the resource table manager.

40. A method of enterprise resource management for an enterprise application on a network comprising:
updating at scheduled intervals to provide current resource availability and performance statistics of resources on the network from a resource manager to a resource table;
initializing a Read command in the enterprise application;
sending the Read command from the enterprise application to a volume interface;
translating the Read command in the volume interface into an internal resource management system File System format for a read manager;
querying for read permission from the write manager to a resource table manager;
checking for permission settings for a target directory from the resource table manager to a resource table.
granting read permission from the resource table manager to the write manager;
determining optimal target resource for information retrieval by the resource table manager;
sending information target resource information from the read/write manager to the server transport service for retrieval;
passing the Read command and block metadata in parallel from the server transport service to the first and second client transport services;
delivering the Read command and block metadata from the first and second client transport services to respective first and second client read managers;
reading information in parallel by the first and second client read managers through first and second enterprise personal computers from first and second resources;
passing the information in parallel from the first and second client read managers to the first and second client transport services;
passing the information in parallel from the first and second client transport services to the server transport service;
passing the information form the server transport service to the read/write manager;
storing the information in the read/write manager;
reconstructing information in the read/write manager;
providing the reconstructed information in the resource management system File System format to the volume interface;
translating the information in the resource management system File System format to information in the enterprise application format by the volume interface; and
providing the information in an enterprise application format from the volume interface to the enterprise application.

41. A method of enterprise storage resource management for an enterprise computer system having an enterprise application and plurality of client computers having storage resources, comprising:
updating current storage resource availability of storage resources on the network by a storage resource manager;
storing data from the enterprise application using a read/write manager;
communicating across the network a first block of the data between the read/write manager to a first client computer having a partially unused first storage resource;
using the partially unused first storage resource for the first block of the data;
communicating across the network a second block of the data between the read/write manager to a second client computer having a partially unused second storage resource; and
using the partially unused second storage resource for the second block of the data.

42. The method of enterprise storage resource management as claimed in claim 41
translating data from the enterprise application to the read/write manager through a volume interface whereby the enterprise application sees the partially unused first and second storage resources as an enterprise application local storage resource.

43. The method of enterprise storage resource management as claimed in claim 41 splitting the data into blocks in the read/write manager.

44. The method of enterprise storage resource management as claimed in claim 41
splitting the data into blocks in the read/write manager; and
determining optimal placement of the blocks in the partially unused first and second storage resources by an storage table manager.

45. The method of enterprise storage resource management as claimed in claim 41
transporting the data across the network using a server transport service and a plurality of client transport services.

46. The method of enterprise storage resource management as claimed in claim 41
updating at scheduled intervals to provide the current storage resources availability and performance statistics of storage resources on the network.

47. The method of enterprise storage resource management as claimed in claim 41
providing a second enterprise computer system and a further client computer having a further storage resource; and
indicating the second enterprise computer system in the storage table manager; and
communicating across the network a further block of the data between the read/write manager to the further client computer having the further storage resource; and
using the further storage resource for the further block of the data.

48. The method of enterprise storage resource management as claimed in claim 41 using mirrored redundant array of independent/inexpensive disk-like mirroring techniques by the storage table manager to ensure that data is secured in a highly redundant fashion in the partially unused first and second storage resources.

49. The method of enterprise storage resource management as claimed in claim 41
using mirrored redundant array of independent/inexpensive disk-like striping techniques by the storage table manager to ensure that data is distributed across the partially unused first and second storage resources to maximize parallel data communication.

50. A method of enterprise storage resource management for an enterprise application on a network comprising:
updating at scheduled intervals to provide current storage resource availability and performance statistics of storage resources on the network from a storage resource manager to a ST;
initializing a Write command in the enterprise application in an enterprise application format;
sending the Write command from the enterprise application to a volume interface;
translating the Write command in the volume interface from the enterprise application format into an internal storage resource management system File System format for a write manager;
querying for write permission from the write manager to a storage table manager.
checking for permission settings for a target directory from the storage table manager to a ST.
granting write permission from the storage table manager to the write manager;
caching files by the write manager;
splitting the files into Data Blocks by the write manager;
querying for each Data Blocks' target list from the write manager to the storage table manager;
querying for storage resource data from the storage table manager to the ST;
calculation of current optimal Resource identifications for storage targets by the storage table manager;
providing Write instructions, listing all Resource identifications for storage from the storage table manager to the write manager;
sending block data and block target data for storage from the write manager to a server transport service;
passing block data and block metadata from the server transport service to a client transport service;
delivering block data from the client transport service to the client write manager;
writing data from the client write manager through an enterprise personal computer to a personal computer storage system;
informing of the success of the Write from the client write manager to the client transport service;
informing of the success of the Write from the client transport service to the server transport service;
informing of the success of the Write from the server transport service to the write manager;
informing of the success of the Write from the write manager to the storage table manager;
updating the location of the stored block from the storage table manager to the ST;
passing block data and block metadata from the server transport service to a second client transport service in target list;
delivering block data from the client transport service to the client write manager;
writing data from the client write manager through a second enterprise personal computer to a second personal computer storage system;
informing of the success of the Write from the client write manager to the second client transport service; and
informing of the success of the Write from the second client transport service to the server transport service.

51. A method of enterprise storage resource management for an enterprise computer system having an enterprise application and a plurality of client computers having storage resources with data, comprising:
updating current storage resource availability of storage resources on the network by a storage resource manager;
requesting the data by the enterprise application using a read/write manager;
communicating across the network requesting the data between the read/write manager to a first and second client computer having respective partially unused first and second storage resources having respective first and second blocks of the data;
providing the first and second blocks of the data in parallel;
communicating across the network the first and second blocks of the data in parallel; and
reconstructing the first and second blocks of the data into the data in the read/write manager; and
providing the data to the enterprise application.

52. The method of enterprise storage resource management as claimed in claim 51
translating data from the read/write manager to the enterprise application through a volume interface whereby the enterprise application sees the partially unused first and second storage resources as an enterprise application local storage resource.

53. The method of enterprise storage resource management as claimed in claim 51
determining optimal target storage resource for the data retrieval by the storage table manager.

54. The method of enterprise storage resource management as claimed in claim 51
determining optimal target storage resource for the data retrieval by the storage table manager; and
using the optimal target storage resource determination for the data retrieval by the read/write manager.

55. The method of enterprise storage resource management as claimed in claim 51
transporting data across the network using a server transport service and a plurality of client transport services operating in parallel.

56. The method of enterprise storage resource management as claimed in claim 51
updating at scheduled intervals to provide the current storage resources availability and performance statistics of storage resources on the network.

57. The method of enterprise storage resource management as claimed in claim 51
providing a second enterprise computer system and a further client computer having a further storage resource having a further block of the data; and
determining the second enterprise computer system in the storage table manager as a further optimal target storage resource; and
communicating across the network the further block of the data between the read/write manager from the further client computer having the further storage resource.

58. The method of enterprise storage resource management as claimed in claim 51 retrieving data stored by mirrored redundant array of independent/inexpensive disk-like mirroring techniques by the storage table manager.

59. The method of enterprise storage resource management as claimed in claim 51
retrieving data stored by mirrored redundant array of independent/inexpensive disk-like striping techniques by the storage table manager.

60. A method of enterprise storage resource management for an enterprise application on a network comprising:
updating at scheduled intervals to provide current storage resource availability and performance statistics of storage resources on the network from a storage resource manager to a ST;
initializing a Read command in the enterprise application;
sending the Read command from the enterprise application to a volume interface;
translating the Read command in the volume interface into an internal storage resource management system File System format for a read manager;
querying for read permission from the write manager to a storage table manager;
checking for permission settings for a target directory from the storage table manager to a ST.
granting read permission from the storage table manager to the write manager;
determining optimal target storage resource for data retrieval by the storage table manager;
sending data target storage resource data from the read/write manager to the server transport service for retrieval;
passing the Read command and block metadata in parallel from the server transport service to the first and second client transport services;
delivering the Read command and block metadata from the first and second client transport services to respective first and second client read managers;
reading data in parallel by the first and second client read managers through first and second enterprise personal computers from partially unused first and second storage resources;
passing the data in parallel from the first and second client read managers to the first and second client transport services;
passing the data in parallel from the first and second client transport services to the server transport service;
passing the data from the server transport service to the read/write manager;
storing the data in the read/write manager;
reconstructing data in the read/write manager;
providing the reconstructed data in the storage resource management system File System format to the volume interface;
translating the data in the storage resource management system File System format to data in the enterprise application format by the volume interface; and
providing the data in an enterprise application format to the enterprise application.

61. An enterprise resource management system for a plurality of unused resources on a network, comprising:
a transport mechanism for communicating with the plurality of unused resources; and
a manager mechanism for aggregating the plurality of unused resources and using an aggregation of the plurality of unused resources as a contiguous local resource.

62. The enterprise resource management as claimed in claim 61 wherein:
the transport mechanism includes a mechanism for communicating with a plurality of portions of contiguous information across the plurality of unused resources.

63. The enterprise resource management as claimed in claim 61 wherein:
the transport mechanism includes a mechanism for communicating in parallel with a plurality of portions of contiguous information across the plurality of unused resources.

64. The enterprise resource management as claimed in claim 61 wherein:
the transport mechanism includes a mechanism for optimizing the communicating with a plurality of portions of contiguous information across the plurality of unused resources.

65. The enterprise resource management as claimed in claim 61 wherein:
the manager mechanism includes a mechanism for deconstructing a plurality of portions of contiguous information to the plurality of unused resources;
the manager mechanism includes a mechanism for reconstructing the plurality of portions of contiguous information from the plurality of unused resources; and
the transport mechanism includes a mechanism for communicating in parallel with the plurality of portions of contiguous information across the plurality of unused resources.

66. The enterprise resource management as claimed in claim 61 wherein:
the unused resources include storage space.

67. A method for enterprise resource management for a plurality of unused resources on a network, comprising:
communicating with the plurality of unused resources;
aggregating the plurality of unused resources; and
using an aggregation of the plurality of unused resources as a standard and contiguous resource.

68. The method of enterprise resource management as claimed in claim 67 including:
aggregating storage resources from a plurality of networked computers; and
presenting the aggregated storage as a contiguous and standard storage resource.
